(19) United States
(12) Patent Application Publication
(10) Pub. No.: US 2012/0037646 A1
(43) Pub. Date: Feb. 16, 2012

(54) DOUBLE WALLED CONTAINER AND METHOD OF MANUFACTURE

(76) Inventors: Paul Robert Dunwoody, Oxfordshire (GB); Paul Charles Claydon, Oxfordshire (GB)

(21) Appl. No.: 13/265,695

(22) PCT Filed: Apr. 23, 2010
(86) PCT No.: PCT/EP2010/055481

§ 371 Date: Oct. 21, 2011

(30) Foreign Application Priority Data
Apr. 23, 2009 (EP) 09158663.6

(51) Int. Cl. B65D 6/00; B21D 51/26; B23P 17/04

(52) U.S. Cl. 220/660; 29/592; 413/1

(57) ABSTRACT

A double walled container comprising an inner container having a sidewall (52) and a base (54) connected thereto, and an outer container (1) having a sidewall (2) and a base (4) connected thereto and arranged to accommodate the inner container, whilst defining a gap therebetween. The sidewall (2) of the outer container has a securement region, which is formed to have a smaller diameter compared with the diameter of the sidewall (52) of the inner container. The inner container may take the form of a filled beverage can (90), which is sealed by an end (70) seamed thereto and is subsequently inserted into a larger outer can during the final stage of production.

### TECHNICAL FIELD

The present invention generally relates to beverage containers and more particularly to double wall beverage containers, which provide some insulation to the contents of the container. Many of such containers of beverage are refrigerated prior to use, but when stored out of a refrigerator or held in a user's hand the contents of the container warms up. However, a double walled container, defining an insulating air gap between the two walls helps to mitigate this warming effect somewhat.

### BACKGROUND ART

US 2008169297 A (COORS BREWING COMPANY) 17.07.2008 describes a double walled container and associated method of manufacture. However the containers described in this document have several disadvantages.

The top of the outer shell or container fits the outside diameter of the sidewall of the inner container, such that the two are held together either by a slight interference or “press” fit. For an interference fit, the inner container must be pushed with significant force into the outer container, and a ventilation hole is required in the outer container to allow trapped air to escape. Such a ventilation hole may subsequently need to be repaired with a patch.

Alternatively, an adhesive process is described to couple the inner and outer containers together. However, application of an adhesive material may be an expensive, messy and time-consuming process.

Also, the top of the metal (steel or aluminium) outer container, as described in US 2008169297 , has a cut-edge, which may be dangerously exposed if the container is damaged and/or dented.

### DISCLOSURE OF INVENTION

Accordingly, the present invention provides a double walled container comprising an inner container, having a sidewall and a base connected thereto, and an outer container having a sidewall and a base connected thereto and arranged to be secured to the inner container whilst defining a gap therebetween, characterised in that a portion of the diameter of the sidewall of the outer container is less than the diameter of the sidewall of the inner container and thereby the inner container is secured within the outer container.

Thus, in the double walled container according to the invention the outer container is secured to the inner container at a portion, whose diameter is less that the diameter of the sidewall of the inner container. Preferably, the outer container is initially larger than the inner container, which may be easily slid therein. Thereafter (once the containers are nested together), a portion of the outer container is formed inwardly so that its diameter is smaller than the associated sidewall of the inner container. In this way, the containers may be secured together without the difficulty of an interference or “press” fit.

An inward curl may be provided around the cut edge or rim of the outer container. This provides cut-edge protection should the double walled container be damaged during handling.

Preferably, the inner container is a conventional beverage container, which is manufactured, filled and sealed using conventional tooling and according to conventional processes. This is particularly advantageous where investment in new tooling and equipment is costly. The manufacture of the outer container and the process of fixing the outer container to the inner container also makes use of conventional techniques and tooling where possible. Thus, the outer container may be applied to a conventional filled and sealed beverage can as the final stage of production, prior to secondary packaging. This has the benefit of minimising damage to the outer container, such as might occur during handling in the conventional filling and sealing process.

Reduction of the susceptibility of the sidewall of the outer container to damage is particularly important in the double walled container according to the invention, because there is no structural support from the product pressure, as in conventional beverage cans. Using an increased wall thickness (compared to that of a conventional beverage can) to enhance the structural rigidity of the outer container is an option, but this increases the cost. It will be apparent to the person skilled in the art that conventional beading may be provided on the sidewall of the outer container to increase structural rigidity. Dimples, which provide support of the sidewall of the outer container by contact with the sidewall of the inner container are also possible, but such contact provides a conduction path for heat from the surroundings outside the double walled container to the product held inside the inner container.

The inventors also considered the addition of pressure in the gap between the inner and outer container walls, to enhance the support provided for the outer container. However, this has to be carefully balanced because if the pressure is excessive, opening the double walled can would result in ejection of the product from the inner container, unless the inner container were beaded to mitigate this affect.

Finally, the inventors have investigated the addition of thermal insulation in the gap between the walls of the inner and outer containers both to enhance the thermal insulation of the double walled container and to provide increased support for the wall of the outer container. However, this increases the complexity of the double walled container assembly and thereby also the cost.

Preferably, the diameter of the outer container is sized to allow the inner container to easily slide centrally inside it prior to inward forming of a portion of the outer container. Alternatively, both the inner and outer containers may have substantially the same dimensions and be produced using the same manufacturing processes. Thereafter, the majority of the sidewall of the outer container may be expanded outwardly to provide the desired gap between the inner and outer container walls. Such manufacturing steps permit both inner and outer containers to be initially formed with similar, standard diameters to avoid major changes to conventional manufacturing equipment.

The inner and outer containers may be made from any metal, although either aluminium or steel in any combination is preferred. Although the use of adhesives is undesirable, the metal used in the manufacture of the inner and outer containers may be coated with organic materials or polymers. As a further step in the manufacturing process, these coatings may be fused or adhered together after inward forming of a portion of the outer container to provide a seal, thus preventing ingress and/or egress of fluids if the containers are placed in iced water to chill, for example. Alternatively a sealant may be applied to the inside of the outer container rim or the adjacent region of the inner container prior to inward forming of the outer container rim.

### BRIEF DESCRIPTION OF FIGURES IN THE DRAWINGS

The invention will now be described, by way of example only, by reference to the accompanying drawings, in which:

FIGS. 1 to 7 illustrate a manufacturing progression for the manufacture of a double-walled beverage can formed using an outer can body having an original diameter larger than that of the inner can.

FIG. 1 is a sectional view of a straight-walled outer can body, with a detailed view (FIG. 1A) of the encircled region shown therein.

FIG. 2 is a sectional view of an inwardly necked outer can body, with a detailed view (FIG. 2A) of the encircled region shown therein.

FIG. 3 is a sectional view of an inwardly necked and curled outer can body, with a detailed view (FIG. 3A) of the encircled region shown therein.

FIG. 4 is a sectional view of the outer can body of FIG. 3 having an expanded rim, with a detailed view (FIG. 4A) of the encircled region shown therein.

FIG. 5 is a sectional view of an assembly comprising a filled and closed inner can body inserted into the outer can body of FIG. 4, with a detailed view (FIG. 5A) of the encircled region shown therein.

FIG. 6 is a sectional view of the assembly of FIG. 5 after the rim of the outer can body has been reduced in diameter to less than the diameter of the inner can body, with a detailed view (FIG. 6A) of the encircled region shown therein.

FIG. 7 gives perspective views of two alternative arrangements of the double-walled beverage can according to the invention, where the inner can is provided by a conventional beverage can (FIG. 7A) and where the inner beverage can is open and ready to be filled, (FIG. 7B).

FIG. 8 comprises two sketches of alternative arrangements illustrating how the invention may be applied to straight walled containers having no neck upon which to fasten the outer container. The first (FIG. 8A) illustrates the use of an internal bead and the second (FIG. 8B) illustrates the use of an external bead.

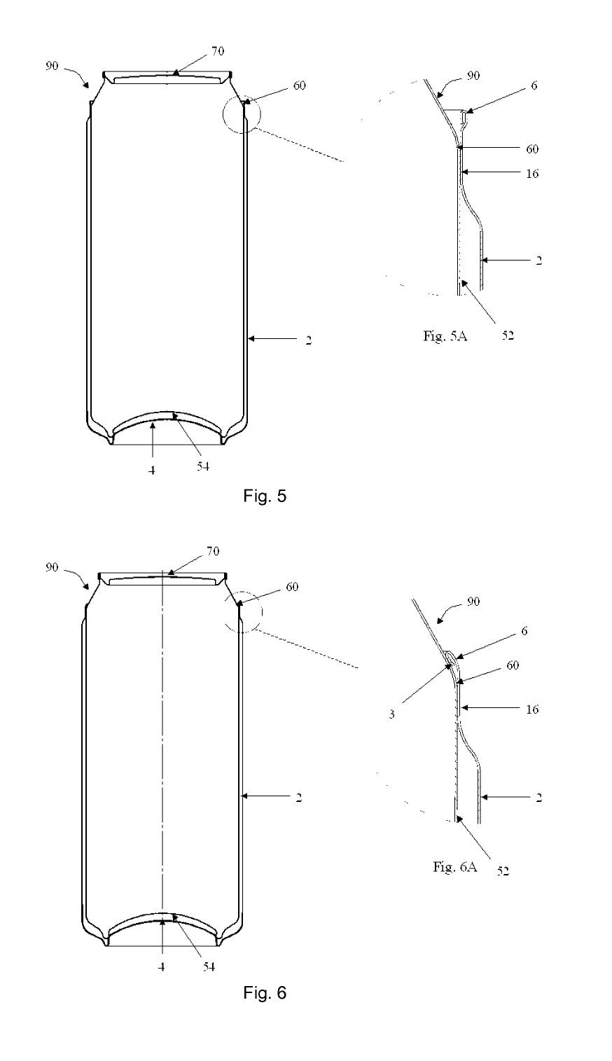

FIG. 1 (including detail FIG. 1A) shows an outer can body 1 comprising a sidewall 2 and a base 4. The sidewall 2 terminates in a cut edge 3 defining an aperture. The diameter of the sidewall 2 is larger than the diameter of an inner can 90 (see FIGS. 5 & 6). The exterior surface of the side-wall 2 is preferably decorated, and the interior surface of the side-wall 2 adjacent to the aperture is preferably coated with a lacquer. The base 4 has a shape similar to a conventional beverage can for convenience of manufacture, but any shape that provides an insulating gap between it and the corresponding base 54 of the inner can 90 (see FIGS. 5 & 6) is preferred to minimise the cost of materials and manufacture.

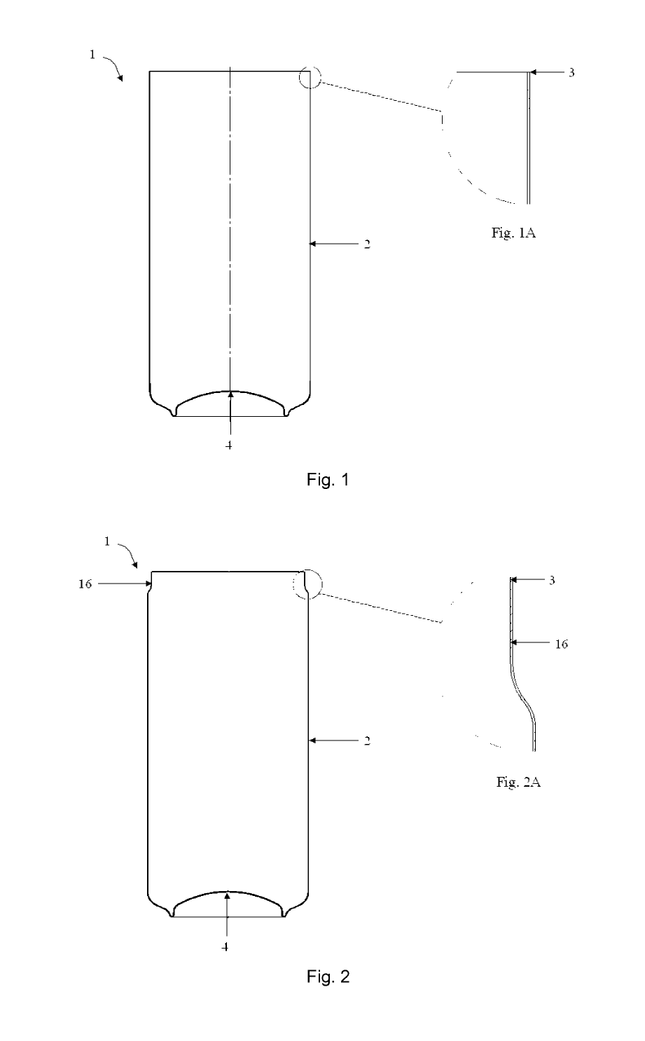

FIG. 2 (including detail FIG. 2A) show an outer can body 1 with a neck 16 at the aperture. The neck 16 may be formed by pushing the outer can body 1 into a tool. The inside diameter of the neck 16 is preferably equal to or slightly larger than the outside diameter of the inner can 90.

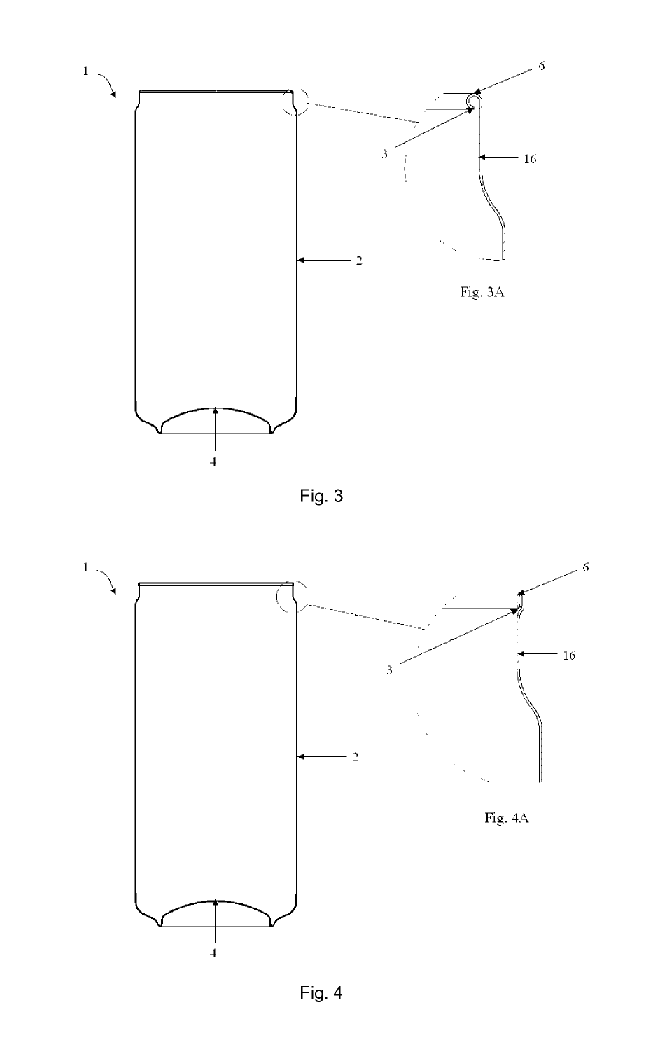

FIG. 3 (including detail FIG. 3A) shows a necked outer can body 1 ,16 with an inward curl 6 about the aperture at the cut edge 3. An inward bend or “pre-curl” (not shown) may be formed at the cut edge 3 to assist in subsequent forming of the curl 6 and to prevent wrinkles or the like. Such a curl 6 may be formed by pushing the cut edge 3 of the can body 1 into a tool, and such a tool preferably comprises one or more profiled rollers arranged to roll around the aperture during forming of the curl 6. In such a tool, the profile of the tool has a radius matching that of the curl 6 to be formed.

FIG. 4 (including detail FIG. 4A) shows an outer can body 1 with the curl 6 modified in shape. Such a “modified curl” may be formed by pushing a tool into the aperture of the outer can 1, to increase the diameter of the inside of the formed curl 8 to that of the neck 16 below. Any increase in the diameter of the outside of the formed curl 6 may be limited by placing a solid ring around the aperture whilst pushing the expansion tool into the aperture. This ensures that the curl 6 does not impede the aperture through which the inner can (not shown) slides into the outer can body 1.

FIG. 5 (including detail FIG. 5A) shows an assembly comprising an inner can 90 inserted into the outer can body 1. Preferably, the curl 6 of the outer can body 1 remains above the shoulder 60 of the inner can 90 after insertion, when the base 54 of the inner can rests on the base 4 of the outer can body 1. Preferably, the inner can 90 is an already-filled beverage can with an end 70 seamed thereon, and preferably this is chilled to help preserve the quality of the can contents.

At this stage, a sealant may be placed in the gap between the curl 6 of the outer can body 1 and the shoulder 60 of the inner can 90.

FIG. 6 (including detail FIG. 6A) shows the assembly of FIG. 5, with the curl 6 formed inwardly to reduce the diameter of the inside of the formed curl 6 to less than the outside diameter of the side-wall 52 of the inner can 90, so that the inside of the formed curl 6 contacts the inner can 90 just above the shoulder 60, thereby securing the inner can 90 and the outer can body 1 together. The cut edge 3 is now safely hidden.

Preferably, the curl 6 is formed inwardly by pushing a profiled tool axially against the outside of the formed curl 6. Preferably, a force is applied between the end 70 of the inner can 90 and the base 4 of the outer can body 1 during this forming operation, to flex the can bases together so that the inner can 90 cannot move axially after forming has been completed and any spring-back has occurred. The profiled tool is preferably provided with contact surfaces to centralise it within the outer can body 1 prior to inwardly forming the curl 6.

If desired, the profiled tool may be pushed further against the outside of the formed curl 6 than shown in FIG. 6, so as to further squash the curl 6 and/or locally deform the inner can 90 to provide either a tighter or a smoother join, and/or the inner can 90, may be provided with an annular recess to accommodate the curl 6.

FIGS. 1 to 6 illustrate an example of a double-walled container formed using an outer can body 1 having an original diameter larger than that of the inner can 90, which is accommodated therein. Alternatively, the outer can body 1 may have an original diameter approximately equal to that of the inner can 90 and the outer can body 1 may then be expanded, so that its diameter is larger than that of the inner can 90.

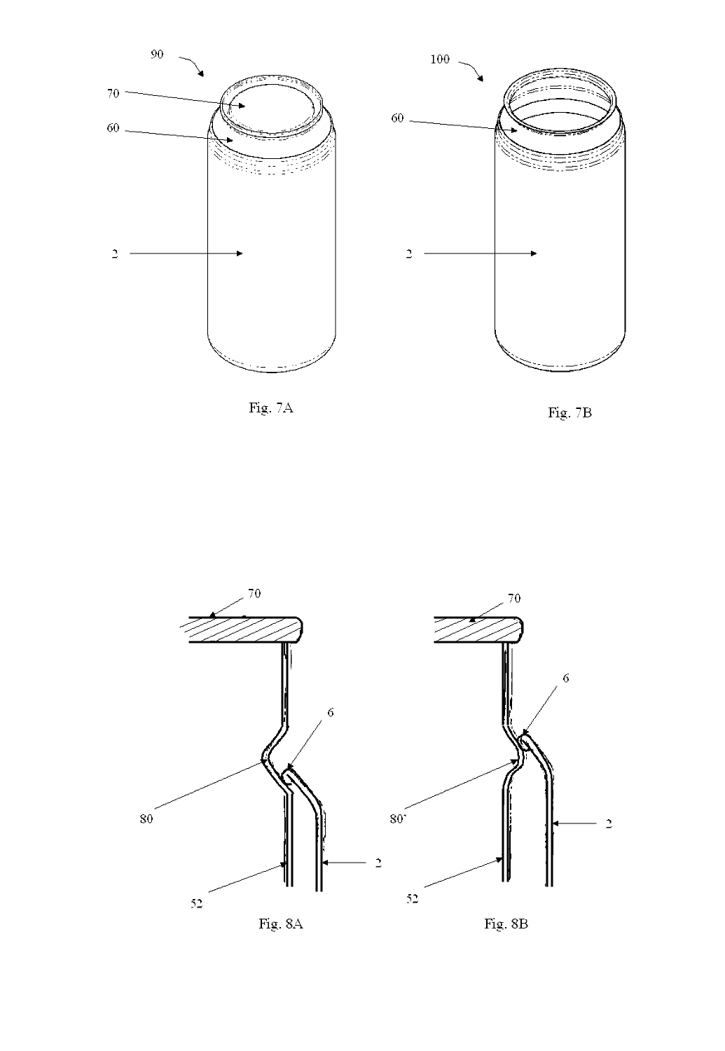

FIG. 7 illustrates another two possible constructions of the double walled can according to the invention. Preferably, the inner can 90 is a conventional, filled and sealed beverage can (FIG. 7A). Note: for simplicity, the end 70 does not show a tab or score, which is present on many conventional beverage ends. However, the double-walled beverage can may be provided by an “open” (unsealed), inner can body (FIG. 7B), which is subsequently fixed inside a larger outer can body 1 and filled and sealed as required.

The invention may also be applied to a straight-walled inner container, which has no neck feature, as illustrated in FIG. 8. This may be achieved by provision of an internal bead 80, or an external bead 80′ to increase the diameter of the sidewall 52 of the inner container, against which the curl 6 about the periphery of the sidewall 2 of the outer container may be secured.

The examples included above are merely illustrative and other features and methods of construction will be apparent to persons skilled in the art are intended to be included within the scope of the present invention. Although both the inner and outer containers shown in the figures have conventionally-shaped bases, for simplicity of manufacture in conventional can-making equipment, alternative shapes could be used to optimize location of the inner and outer container together and to optimize the amount of metal used.

1. A double walled container comprising:
an inner container having a sidewall and a base connected thereto,
an outer container having a sidewall and a base connected thereto and arranged to accommodate the inner container, whilst defining a gap therebetween,
wherein a portion of the diameter of the sidewall of the outer container is less than the diameter of the sidewall of the inner container and thereby the inner container is secured within the outer container.

2. A double walled container according to claim 1, wherein the sidewall of the outer container is formed inwardly to provide a portion of reduced diameter to secure the inner container and the outer container together.

3. A double walled container according to claim 1, wherein the sidewall of the inner container is substantially cylindrical and the free-end of the sidewall of the outer container defines a rim that is inwardly formed to a diameter less than the diameter of the cylindrical sidewall of the inner container.

4. A double walled container according to claim 3, wherein the rim is formed into a curl.

5. A double walled container according to claim 1, wherein the sidewall of the inner container has one or more indentations around its circumference and a portion of the outer container is arranged to conform to the reduced diameter of the indentations in the sidewall of the inner container.

6. A double walled container according to claim 1, wherein the gap between the sidewall of the outer container and the sidewall of the inner container is filled with thermal insulation and/or a support structure.

7. A double walled container according to claim 1, wherein the gap between the sidewall of the outer container and the sidewall of the inner container is pressurised.

8. A double walled container according to claim 1, wherein the inner and outer containers are made of metal.

9. A method of manufacture of a double walled container, comprising the steps of:
taking an inner container having a sidewall and a base connected thereto,
forming an outer container adapted to accommodate the inner container,
sliding the inner container into the outer container, to define a gap therebetween,
forming the outer container to a diameter less than the diameter of the sidewall of the inner container and thereby securing the inner container within the outer container.

10. A method of manufacture of a double walled container according to claim 9, wherein a product is filled into the inner container and sealed therein, before sliding the filled and sealed inner container into the outer container.

11. A method of manufacture of a double walled container according to claim 9, wherein the inner and outer containers are made from sheet metal.

12. A method of manufacture of a double walled container according to claim 11, wherein the sheet metal is coated with a coating containing organic materials or polymers.

13. A method of manufacture of a double walled container according to claim 12, wherein the coating applied to the inner and/or outer containers is fused together after the outer container is necked in to a diameter less than the diameter of the sidewall of the inner container.
